(19) United States
(12) Patent Application Publication
(10) Pub. No.: US 2002/0106424 A1
(43) Pub. Date: Aug. 8, 2002

(54) Y-aminobutyric acid-containing natural food material and method for manufacturing the same

(75) Inventors: Yoshihiro Ogawa, Noda-shi (JP); Hitomi Yamaguchi, Noda-shi (JP); Youko Shimaoka, Noda-shi (JP)

Correspondence Address: YOUNG & THOMPSON, 745 SOUTH 23RD STREET 2ND FLOOR, ARLINGTON, VA, 22202

(73) Assignee: KIKKOMAN CORPORATION, NODA-SHI (JP)

(21) Appl. No.: 10/062,491

(22) Filed: Feb. 5, 2002

(30) Foreign Application Priority Data
Feb. 5, 2001 (JP) 2001-027950
Nov. 26, 2001 (JP) 2001-359291

(51) Int. Cl. A23K 1/00

(52) U.S. Cl. 426/52

(57) ABSTRACT

A natural food material with a high content of γ-aminobutyric acid is provided, without any additional glutamic acid separately prepared, by treating a glutamine-containing raw material with glutamic acid decarboxylase and glutaminase so that γ-aminobutyric acid can be produced not only from the glutamic acid but also from glutamine in the raw material. Also, a natural food material with a high content of γ-aminobutyric acid is easily and effectively provided with using a typical production process by catalyzing the reaction with a microorganism having the activity of glutamic acid decarboxylase, which is provided as an enzyme of glutamic acid decarboxylase.

### BACKGROUND OF THE INVENTION

The present invention relates to a natural food material with a high content of γ-aminobutyric acid (hereinafter, also referred to as “GABA”) which has been widely noticed as a compound with the function of depressing the elevation of blood pressure (i.e., hypotensive activity). The present invention also relates to a method for manufacturing such a novel natural food material.

GABA is an inhibitory neurotransmitter found in brain and spiral cord of mammals and has the functions of: facilitating a blood flow in the brain to increase the supply of oxygen so as to accentuate a brain metabolism; decreasing the blood pressure by acting on the vasomotor center of spiral cord; inhibiting the secretion of vasopressin (antidiuretic hormone) to decrease the blood pressure by its vascular dilator action; and increasing the hexokinase activity to be required in an introductory part of the TCA cycle to accelerate a carbohydrate metabolism, involving in various kinds of physiological effects, as described in Jpn. J. Physiol. 5, 334-341, 1955 and Jpn. J. Physiol. 8, 378-390, 1958, so GABA is used for medicine for the purpose of brain metabolic activation.

Therefore, the improvement of hypertension can be expected by taking GABA as a food material into the body, so some foods appropriately processed to increase their GABA contents, such as GABA-rich rice germ and Gabaron tea (green tea extract), have been proposed. For example, the GABA-rich rice germ is provided as food with the GABA content being increased to 0.3% by subjecting rice germs into the anaerobic treatment (the GABA-rich rice is commercially available from Oryza Oil and Chemical Co., Ltd.). Also, Gabaron tea is obtained by subjecting tea leaves into the anaerobic treatment and the content of GABA in the tea leaves is increased to 220 mg/100 g, which is several ten times more than the content of GABA before the treatment (Biosci. Biotechnol. Biochem., Vol. 61, No. 11, p1449-1451, 1987, published by Japan Society for Bioscience, Biotechnology, and Agrochemistry; and Japanese Utility Model Laid-Open No. 63-103285). Even though these foods have the enriched GABA contents derived from their respective natural raw materials, the content is still low.

It was reported that a microorganism, especially lactic acid bacteria (lactobacillus) has glutamic acid decarboxylase activity and produces GABA from glutamic acid by the aid of such an enzyme (Abstracts of the annual meeting of Fermentation Society, page 234, 1981). Based on this knowledge, various kinds of foods and food materials containing GABA have been developed and studied.

Several attempts to increase the GABA content in food by converting glutamic acid in the natural raw material into GABA have been known in the art, for example a method of manufacturing GABA by a bacterial fermentation of tomato juice by lactic acid bacteria (Japanese Patent Laid-Open Publication No. 2000-308457) and a method of manufacturing GABA by growing lactic acid bacteria having the abilities of producing glutamic acid decarboxylase and protease in a protein containing glutamic acid as a constitutive amino acid (Japanese Patent Application No. 11-114831 (Japanese Patent Laid-Open Publication No. 2000-014356)). In these methods, however, the GABA contents in the resulting food and food material are influenced by the amount of the glutamic acid contained in the raw material to be used. Therefore, it is difficult to say that the GABA contents in such food and food material are sufficient to attain the desired physiological effects.

On the other hand, alternative methods have been proposed for obtaining the food or food material having a high content of GABA, wherein glutamic acid or salt thereof separately prepared by another process is added to a natural raw material. For example, Japanese Patent Laid-Open Publication No. 7-227245 discloses a method of obtaining a GABA-containing fermented food by incubating lactic acid bacteria having the ability of producing GABA in milk added glutamic acid (salt); Japanese Patent Laid-Open Publication No. 9-238850 discloses a method of manufacturing GABA-enriched food materials by an action of a cell-homogenized solution of yeast or chlorella on glutamic acid (sodium salt); and Japanese Patent No. 2704493 discloses a method of manufacturing a GABA-containing fermented food by adding Lactobacillus plantarum or an unrefined brewing product that contains Lactobacillus plantarum into unrefined fish sauce, squeezed liquid thereof, or fish sauce that contains L-glutamic acid, followed by fermenting the mixture. Although a high content of GABA can be found in the food and food material obtained by those methods, it is noted that they are obtained by adding the glutamic acid which is not contained in each of their original food materials. Therefore, it is difficult to say that they are preferable foods and food materials from a viewpoint of balance among original taste, original redolence, and the like of the foods, taste for natural foods, and so on.

### SUMMARY OF THE INVENTION

An object of the present invention is to provide a food material with a high content of γ-amino butyric acid (GABA) as compared with the conventional one and a method for manufacturing such a food material from a natural raw material, by efficiently producing GABA from components contained in the raw material without adding of glutamic acid which is separately prepared.

The present inventors have been diligently studied to solve the above problems, as a result, found that a natural food material with a high content of GABA, compared with the conventional one, can be obtained by treating a raw material containing glutamic acid and glutamine with glutamic acid decarboxylase and glutaminase without adding glutamic acid which is separately prepared, and finally completed the present invention. Therefore, one aspect of the present invention is to provide a method for manufacturing a natural food material with a high content of GABA, characterized by treating a glutamine-containing raw material with glutamic acid decarboxylase and glutaminase. The other aspect of the present invention is to provide a natural food material with a high content of GABA obtained by the method.

According to the method of the present invention, a natural food material with a high content of γ-aminobutyric acid, compared with the conventional one, is obtainable from a natural raw material itself by effectively producing GABA from components contained in the raw material without adding glutamic acid which is separately prepared. It can be expected that physiological effects such as improvement of hypertension will be attained by taking the food material obtained by the method of the present invention as a food into the body.

### DETAILED DESCRIPTION OF THE INVENTION

Hereinafter, the present invention will be described in detail. A glutamine-containing raw material to be used in the present invention may be one selected from various raw materials containing glutamine that is a kind of amino acids. Among them, preferably, it is one typically used in the production of foods. Glutamine may be present in such a raw material in a form of a free amino acid being free from protein or peptide in the raw material. Alternatively, glutamine may be contained as one of constitutive amino acids of protein or peptide in the raw material. Thus, it is not limited to a specific form of glutamine. Where glutamine is contained as a constitutive amino acid of protein or peptide in the raw material, it is preferable to use the raw material after decomposing protein or peptide to liberate free glutamine by a general decomposing treatment.

The glutamine-containing materials include vegetable protein materials such as grains and legumes; animal protein materials such as dairy products, fishes, and meats; protein materials separated from these animal and vegetable protein materials; process materials obtained by processing these animal and vegetable protein materials. More concretely, for example, the vegetable protein materials include cereals such as wheat, wheat germ, wheat bran, oatmeal, barley, rice, rice germ, brown rice, rye, flour, wheat gluten, foxtail millet, corn, field peas, buckwheat, and adlay; beans such as soybean, soybean powder, soybean protein, peanut, azuki bean, kidney bean, broad bean, soybean flour, cowpea, and green peas; and proteins obtained from beans and cereals such as wheat gluten, corn gluten, isolated soybean protein, extracted soybean protein, and soy milk. In addition, the animal protein materials include fish meat, dairy products, animal meat, casein, and gelatin.

Although these protein materials contain free glutamine, the great mass of glutamine is included as constitutive amino acid of protein or peptide. Therefore, it is desirable to decompose the protein or the peptide having the glutamine as constitutive amino acid to liberate free glutamine by performing the typical decomposition treatment well known in the art, such as chemical or physical treatment, or biological treatment using microorganism or enzyme.

In the case of the glutamine-containing material in which the above glutamine is included as a constitutive amino acid of protein or peptide, it is desirable to decompose the protein or the peptide in advance. In the food industrial field, the method of decomposing protein or peptide having glutamin into free glutamine by a proteolytic enzyme such as protease is preferably used. In such a decomposition process, glutamic acid which constitutes protein or peptide of the glutamine-containing raw material can be simultaneously decomposed into free glutamic acid. It is especially desirable for the production of natural food materials with a high content of GABA of the present invention. This decomposition process can also be performed simultaneously with the step of treating with glutaminase and the step of treating with glutamic acid decarbonization enzyme described bellow. On the other hand, there is a case that undecomposed peptides derived from the original raw material are found in the raw material obtained by the decomposition with using these proteolytic enzymes. It is known that some of such undecomposed peptides have various physiological activities including antihypertensive action. In the present invention, therefore, using the raw material obtained by the above decomposition is more preferable because the effects of these various physiological activities will be interactive to the effects on GABA.

Enzyme, microorganism, and conditions to be used in the above decomposition process may be those typically used in the art. The enzyme to be used is not limited to a specific one as long as it possesses protease activities. For example, various kinds of commercially available protease preparation may be allowable in addition to the product of microbial culture, especially the product of koji bacteria (solid koji, liquid koji) such as soy sauce koji. The addition amount of protease used for the decomposition process may meet the conditions by which glutamine and glutamic acid (constitutive amino acids in the protein raw material) are liberated from the raw material. For example, the addition amount of protease is in the range of 50 to 10,000, preferably 200 to 6,000, and more preferably 400 to 4,000 units per 1 gram of the protein raw material. The decomposition temperature may be in the range from 20 to 80° C., preferably 30 to 70° C. and more preferably 40 to 55° C. In addition, the decomposition time may be in the range of 4 to 48 hours, preferably 12 to 36 hours, and more preferably 16 to 24 hours. The decomposition process may be performed in the solid state or may be performed in the liquid state.

In the present invention, the activity of protease was assayed with using milk casein as a reaction substrate. That is, 1 ml of 2% milk casein solution kept at 30° C. for 10 minutes, and 1 ml of enzyme-containing solution diluted moderately were mixed and then reacted at 30° C. for 30 minutes. Four ml of 5% trichloroacetic acid (TCA) was added to the reaction mixture. Subsequently, the mixture was left to stand at 30° C. for 30 minutes to denature and precipitate the unreacted milk casein, followed by passing through a No. 5C paper filter (manufactured by Advantech Co., Ltd.). Then, 5 ml of 0.4 M sodium carbonate solution was added to 1 ml of the filtrate and subsequently 1 ml of 5-fold diluted phenol reagent (manufactured by Nacalai-tesque Co., Ltd.) was added. The resulting mixture was subjected to a spectroscopic analysis to determine the content of solubilized protein in the mixture from its absorbance at 660 nm. On the other hand, the enzyme activity was defined such that one unit of the enzyme activity may correspond to the amount of enzyme required for liberating protein equivalent to 1 μg of tyrosine within 1 minute under the above conditions.

Glutaminase to be used in the present invention is an enzyme which act on glutamine for catalyzing the reaction of producing glutamic acid, so that any enzyme or material may be used as long as it possesses such an activity. For example, the commercially available glutaminase preparation may be preferably used. Also, glutaminases which have been reported in the publications, such as salt-resistance glutaminase (Japanese Patent Laid-Open Publication No. 63-94975) and heat-stable glutaminase (Japanese Patent Publication No. 49-48759) may be preferably used. Furthermore, any microorganism having the glutaminase enzyme activity, for example one having the ability of producing glutaminase, may be used.

Next, the above glutaminase was added to the glutamine-containing raw material to convert the free glutamine (also the free glutamine obtained in the decomposition process) into glutamic acid. The addition amount of glutaminase used in this conversion step may be enough to convert the free glutamine into glutamic acid. For example, it may be in the range of 0.01 to 50, preferably 0.1 to 10, and more preferably 0.3 to 5 units per 1 gram of the protein raw material. In the present invention, the activity of glutaminase was estimated by determining the quantity of glutamic acid produced with using glutamine as a reaction substrate. That is, 0.6 ml of 2% glutamine solution and 0.2 ml of moderately diluted enzyme-containing solution were mixed together and allowed to react at 37° C. for 30 minutes. The reaction was terminated by the thermal treatment in boiled water for 5 minutes. After cooling with cold water, 0.2 ml of the mixture was taken and subjected to a spectroscopic analysis to determine the content of produced glutamic acid from its absorbance at 492 nm with using “F-Kit-glutamic acid” (Boehringer Ingelheim Co., Ltd.). On the other hand, the enzyme activity was defined such that one unit of the enzyme activity may correspond to the amount of enzyme required for producing 1 μmole of L-glutamic acid within 1 minute under the above conditions.

The conditions of the reaction of glutaminase for converting the free glutamine into glutamic acid may be those of the typical enzyme reaction. For example, the reaction temperature is in the range of 20 to 80° C., preferably 30 to 70° C., and more preferably 40 to 55° C. The reaction time is in the range of 4 to 48 hours, preferably 12 to 36 hours, and more preferably 16 to 24 hours for converting the free glutamine into glutamic acid.

As a result of the conversion step, the amount of free glutamic acid is the sum of the amount of glutamic acid originally contained in the glutamine-containing raw material and the amount of glutamic acid converted from glutamine contained in the glutamine-containing raw material with glutaminase. Thus, the amount of free glutamic acid can be remarkably increased. The converting process may be performed in the solid state or may be preferably performed in the liquid state.

In the subsequent steps, GABA is prepared from the converted glutamic acid and the free glutamic acid as described above. For preparing GABA, glutamic acid decarboxylase or microorganism having the activity of glutamic acid decarboxylase is used. Glutamic acid decarboxylase is an enzyme that catalyzes the reaction of converting glutamic acid into GABA, which is produced by various kinds of creatures including plants and microorganisms and can be found widely in nature. In the present invention, as glutamic acid decarboxylase any kind of materials can be used as long as it has the activity of glutamic acid decarboxylase. Concrete examples of glutamic acid decarboxylase include one derived from plant such as rice germ and pumpkin fruit and one derived from microorganism such as lactic acid bacteria, especially Lactobacillus brevis IFO12005 (Biosci. Biotech. Biochem., 61 (7), 1168-1171, 1997), Lactobacillus brevis TY414 (Japanese Patent Application No. 11-13635 (Japanese Patent Laid-Open Publication No. 2000-210075)), koji bacteria, and yeast. Any form or purity (the degree of purification) of the glutamic acid decarboxylase may be allowable as long as it is to be within acceptable limits in the food production. For example, the above plant tissue or microorganism having the activity of glutamic acid decarboxylase may be directly used, or their glutamic acid decarboxylase after crude purification or the product at each step of the purifying may be also used. Any commercially available enzyme preparation having the activity of glutamic acid decarboxylase can be effectively used in the present invention. For the food production, to efficiently produce GABA from glutamic acid, it is especially preferable to use microorganism having the activity of glutamic acid decarboxylase. Various species of lactic acid bacteria having the activity of glutamic acid decarboxylase and generally used for food production, such as Lactobacillus sp., Lactococcus sp., Bifidobacterium sp., can be used as the microorganism. Where 5% or more of common salt is contained, it is effective to use salt-resistant lactic acid bacteria.

Next, the above glutamic acid decarboxylase is added to the glutamic acid-containing raw material to initiate the reaction to covert free glutamic acid in the raw material into GABA. The added amount of glutamic acid decarboxylase to be used in such a conversion step may be one enough to convert the free glutamic acid into GABA. For example, the added amount of glutamic acid decarboxylase is in the range of 0.01 to 1,000, preferably 0.1 to 100, and more preferably 1 to 10 units per 1 gram of glutamic acid.

In the present invention, the activity of glutamic acid decarboxylase was measured as follows. That is, 3 ml of a substrate solution (50 mM citrate buffer solution having a sodium glutamate final concentration of 1%, pH4.8) kept at 30° C. for 10 minute in advance and, 1 ml of an enzyme solution was mixed and allowed to react at 30° C. for 1 hour. Then, 100 μl of the reaction mixture was added into 50 ml of 0.2N hydrochloric acid solution to terminate the reaction. The amount of GABA produced in the mixture was measured by an amino acid analysis (High-Speed Amino Acid Analyzer L-8800, supplied by Hitachi Corporation). The enzyme activity was defined so that one unit of the enzyme activity may correspond to the amount of enzyme required for producing 1 μmole of GABA within 1 minute under the above conditions.

The conditions of the reaction of glutamic acid decarboxylase for converting the free glutamic acid into GABA may be those of the typical enzyme reaction. For example, the reaction temperature is in the range of 15 to 60° C., preferably 20 to 50° C., and more preferably 20 to 35° C. and the reaction time is in the range of 4 to 72 hours, preferably 12 to 60 hours, and more preferably 24 to 48 hours.

For producing GABA from glutamic acid with using lactic acid bacteria having the activity of glutamic acid decarboxylase, a sufficient amount of lactic acid bacteria biomass may be added in the reaction mixture. On the other hand, in the field of food production, the method in which fermentation with lactic acid bacteria is performed is preferably used in general. For fermenting a glutamic acid-containing solution with lactic acid bacteria having the activity of glutamic acid decarboxylase, for example, a liquid culture which is performed in the general fermentation is preferable. In this case, the culture temperature is in the range of 20 to 50° C., preferably 25 to 45° C., and more preferably 30 to 40° C. and the time of the culture is in the range of 1 to 10 days, preferably 2 to 8 days, and more preferably 4 to 7 days. Under these culture conditions, for increasing the growth rate of lactic acid bacteria, carbon sources such as glucose, lactose, fructose, sucrose, and starch and other substances to be generally used in the culture medium for lactic acid bacteria may be added.

Furthermore, condensed microorganism biomass haying the activity of glutamic acid decarboxylase may be used for producing GABA in a short time.

The step of producing GABA from glutamic acid may be performed simultaneously with the step of decomposing the glutamine-containing raw material and also simultaneously with the step of converting glutamine into glutamic acid. For example, a commercially available glutaminase preparation is added into a decomposition solution obtained by decomposing the glutamine-containing raw material, and simultaneously glutamic acid decarboxylase or lactic acid bacteria having the activity of glutamic acid decarboxylase is added thereinto to initiate the reaction.

Accordingly, the natural food material with a high content of GABA according to the present invention is obtainable by the manufacturing method of the present invention. The natural food materials to be obtained are food materials, including general foods, without containing any additives separately prepared. For example, fermented or brewing food, such as soy sauce, bean paste, fish sauce, enzyme decomposition seasoning, yogurt, and a cheese is preferable. In the natural food material with a high content of GABA obtained by the present invention, the content of GABA is higher than that of the food material obtained by the conventional method. For example, the content of GABA in the natural food material of the present invention is in the range of 1 to 100 mg, preferably in the range of 10 to 50 mg, per 1 gram of the natural food material.

In the present invention, the GABA content in the food material is determined by an amino acid analysis method. That is, a sample is diluted 500 folds with 0.02N of hydrochloric acid, followed by a measurement with using an amino acid analysis instrument (High-Speed Amino Acid Analyzer L-8800, supplied by Hitachi Corporation).

According to the present invention, therefore, there is no need to add glutamic acid separately prepared by another process because glutamine included in the food raw material as an original component is used. Thus, the natural food materials with a high content of GABA can be obtained economically.

That is, the food material of the present invention is one with a GABA content higher than that of the conventional food or food material well known in the art, so that the food or food material of the present invention is preferable compared with the conventional high GABA-content food materials obtained by adding glutamic acid from a viewpoint of balance among original taste, original redolence, and the like of the foods, taste for natural foods, and so on. Furthermore, natural food materials with a high content of GABA in accordance with present invention, which is obtained from the glutamine-containing raw material through the decomposition process, is also expected to include undecomposed peptide having antihypertensive action. Thus, it can be used as a nutrient medical supplement to be expected as an antihypertensive agent. It is also possible to produce a healthy functional food in which the food materials with a high content of GABA of the present invention is mixed with other food material having antihypertensive action such as peptide and nicotinamine and a health-conscious food prepared by adding the food materials of the present invention into food and drink such as bread, sweet stuff, bean paste, yogurt, cheese, soy source, soup, dip, juice, and soft drink.

Hereinafter, the present invention will be described in more detail with reference to examples and experimental examples. However, the technical scope of the present invention is not limited to these examples.

### Example 1

### The Production 1 of Powdery Food Material Using a Glutamine-Containing Raw Material in Accordance With the Present Invention

Using a conventional method, at first, a powdery food material was prepared as a control for a comparison. Seventy grams of wheat gluten and 100 grams of soy source koji were added into 160 ml of hot water. Then, the decomposition reaction was carried out at 50° C. for 24 hours. The decomposed product was sterilized by heating at 121° C. for 10 minutes, followed by inoculating lactic acid bacteria (Lactobacillus brevis IFO3960) into the sterilized mixture. Subsequently, it was incubated at 30° C. for 7 days. The resulting culture was filtered through a paper filter and Celite filter to remove the bacteria to obtain a brown solution. The GABA content in this solution was 2.6 mg/ml. Then, the resulting solution was freeze-dried to obtain 58 grams of the control powdery food materials with 0.9% in GABA content.

Next, a powdery food material was prepared by the method of the present invention. As in the case with the above control, a mixture of wheat gluten, soy source koji, and hot water was prepared. On the other hand, a culture medium of Candida famata KM-1 (FERM P-8997) was used as glutaminase. That is, Candida famata was cultured in a culture medium (the composition of the culture medium: 6% glucose, 1.0% yeast extract, 0.1% potassium phosphate, and 0.1% magnesium sulfate, pH5.5, culture temperature: 30° C.) with agitation for 36 hours under aeration. Then, 5 ml of the culture medium was added to the above mixture to simultaneously initiate the decomposition and conversion reactions. Subsequently, lactic acid bacteria (Lactobacillus brevis IFO3960) was inoculated in the mixture and then incubated at 30° C. for 7 days. The resulting culture was filtered through a paper filter and Celite filter to remove the bacteria to obtain a brown solution. The GABA content in this solution was 13.0 mg/ml. Then, the resulting solution was freeze-dried to obtain 57 grams of the powdery food material with a GABA content of 5.4% according to the present invention.

From the above results, the amount of GABA contained in the powdery food material of the present invention was substantially higher than that of the control food material.

### Example 2

### The Production 2 of a Powdery Food Material Using a Glutamine-Containing Raw Material in Accordance With the Present Invention

In this example, the control powdery food material and the powdery food material of the present invention were prepared by the same way as that of Example 1 except that 120 ml of liquid koji was used in stead of 100 grams of soy source koji in the decomposition step.

The liquid koji was prepared by the general method described in Journal of Fermentation Society, vol. 69, No. 6, 441-446, 1991. Then, 120 grams of liquid koji and 70 grams of wheat gluten were mixed and then 80 ml of hot water was added to the mixture, allowing the decomposition reaction at 50° C. for 24 hours. The decomposed product was sterilized by heating at 121° C. at 10 minutes. Then, lactic acid bacteria (Lactobacillus brevis IFO 3960) was inoculated in the sterilized product and cultured at 30° C. for 7 days. The resulting culture was filtered through a paper filter and Celite filter to remove the bacteria to obtain a brown solution. The GABA content in this solution was 2.8 mg/ml. Then, the resulting solution was freeze-dried. Consequently, 59 grams of the control powdery food material with 1.1% in GABA content was obtained.

Next, a powdery food material was prepared by the method of the present invention. As in the case with the above control, the mixture of wheat gluten, liquid koji, and hot water was prepared. Ten ml of the culture medium of Candida famata KM-1 (FERM P-8997) prepared by the same way as Example 1 was added as glutaminase to the above mixture to simultaneously initiate the decomposition and conversion reactions. Subsequently, lactic acid bacteria (Lactobacillus brevis IFO3960) was inoculated in the mixture and then incubated at 30° C. for 7 days. The resulting culture was filtered through a paper filter and Celite filter to remove the bacteria to obtain a brown solution. The GABA content in this solution was 13.5 mg/ml. Then, the resulting solution was freeze-dried. Consequently, 55 grams of the powdery food material with 5.5% in GABA content of the present invention was obtained.

From the above results, just as in the case with Example 1, the amount of GABA contained in the powdery food material of the present invention was substantially higher than that of the control food material.

### Example 3

### The Production 3 of a Powdery Food Material Using a Glutamine-Containing Raw Material in Accordance With the Present Invention

In this example, a pineapple juice was used as protease in the decomposition process and a culture medium of Cryptococcus albidus (FERM P-1291) was used as glutaminase in the conversion process. The culture of the bacteria was performed by the same way as that of Candida famata used in Example 1.

A mixture of 70 grams of wheat gluten and 120 grams of pineapple juice prepared from a commercially available pineapple was prepared. Then, 80 ml of hot water was added to the mixture and the decomposition reaction of the resulting mixture was carried out at 50° C. for 24 hours. The decomposed product was sterilized by heat at 121° C. for 10 minutes. Subsequently, lactic acid bacteria (Lactobacillus brevis IFO3960) as used in Example 1 was inoculated into the sterilized mixture and then incubated at 30° C. for 7 days. The resulting culture was filtered through a paper filter and Celite filter to remove the bacteria to obtain a brown solution. The GABA content in this solution was 0.5 mg/ml. Then, the resulting solution was freeze-dried. Consequently, 60 grams of the control powdery food material with 0.8% in GABA content was obtained.

Next, a mixture of wheat gluten, pineapple juice, and hot water was prepared by the same way as that of the above control. Then, 5 ml of the culture medium of Cryptococcus albidus (FERM P-1291) was added as glutaminase to the above mixture to simultaneously initiate the decomposition and conversion reactions. Subsequently, just as in the case with the above control, lactic acid bacteria (Lactobacillus brevis IF03960) was inoculated and cultured, followed by filtration for removing the bacteria. As a result, a brown solution was obtained. The GABA content in this solution was 13.0 mg/ml. Then, the resulting solution was freeze-dried. Consequently, 55 grams of the powdery food material with 5.2% in GABA content according to the present invention was obtained.

### Example 4

### The Production 4 of a Powdery Food Material Using a Glutamine-Containing Raw Material in Accordance with the Present Invention

In this example, AO protease (manufactured by Seisin Seiyaku, Co., Ltd.) was used as protease in the decomposition process and commercially available Glutaminase Daiwa C-100 (manufactured by Daiwakasei, Co., Ltd.) was used as glutaminase in the conversion process.

As the control, at first, 180 ml of hot water was added to a mixture of 70 grams of wheat gluten and 2.5 grams of AO protease (manufactured by Seisin Seiyaku, Co., Ltd.), allowing the decomposition reaction at 50° C. for 24 hours. After sterilizing the decomposed product by heating at 121° C. for 10 minutes, lactic acid bacteria (Lactobacillus brevis IFO3960) as used in Example 1 was inoculated in the sterilized mixture and cultured at 30° C. for 7 days. The resulting culture was filtered through a paper filter and Celite filter to remove the bacteria to obtain a brown solution. The GABA content in this solution was 3.2 mg/ml. Then, the resulting solution was freeze-dried. Consequently, 60 grams of the powdery food material with 1.2% in GABA content.

Next, just as in the case with the above control, a mixture of wheat gluten, AO protease, and hot water was prepared. Then, 0.2 grams of Glutaminase Daiwa C-100 (manufactured by Daiwakasei, Co., Ltd.) as glutaminase was added to the mixture, allowing the decomposition reaction at 50° C. for 24 hours. After the decomposition, lactic acid bacteria (Lactobacillus brevis IFO3960) as used in Example 1 was inoculated in the mixture and cultured at 30° C. for 7 days. The resulting culture was filtered through a paper filter and Celite filter to remove the bacteria to obtain a brown solution. The GABA content in this solution was 15.8 mg/ml. Then, the resulting solution was freeze-dried. Consequently, 60 grams of the powdery food material with 5.9% in GABA content according to the present invention was obtained. In this example, just as in the case with the previous Examples 1, 2, and 3, the amount of GABA contained in the powdery food material of the present invention was substantially higher than that of the control food material.

### Experimental Example 1

### Preparation of Glutamic Acid Decarboxylase

Glutamic acid decarboxylase was prepared in accordance with the method described by Ueno et al. in Biosci. Biotech. Biochem., 61 (7), 1168-1171, 1997. That is, Lactobacillus brevis IFO12005 was inoculated in 20 litters of GYP culture medium (1% glucose, 1% yeast extract, 0.5% polypeptone, 1% sodium glutamate) and incubated in a jar fermenter (30-litter volume) at 30° C. for 72 hours. After the incubation, the bacterial cells were collected by centrifugation at 8,000×g for 30 minutes. One litter of a buffer solution (0.1 mM pyridoxal phosphate and 0.1 mM mercaptoethanol in 20 mM phosphate buffered saline, pH7) was added to 100 grams of the collected bacterial cells (wet cells), followed by adding 10 ml of lysozyme solution (0.2 mg/ml) and treating at 37° C. for 15 minutes. After the treatment, the bacterial solution was sonicated by an ultrasonic breaker (Sonic: manufactured by Nippon Seiki Seisakusyo Co., Ltd.) and then centrifuged at 20,000×g for 30 minutes. Then, precipitate was removed to obtain a glutamic acid decarboxylase solution (crude enzyme solution, 3 units/ml).

### Example 5

### The Production 5 of a Powdery Food Material Using a Glutamine-Containing Raw Material in Accordance With the Present Invention

A powdery food material of the present invention was prepared using the glutamic acid decarboxylase obtained in Experimental Example 1.

First, as the control, 180 ml of hot water was added to a mixture of 70 grams of wheat gluten and 2.5 grams of AO protease (manufactured by Seisin Seiyaku, Co., Ltd.) , allowing the decomposition reaction at 50° C. for 24 hours. After sterilizing the decomposed product by heating at 121° C. for 10 minutes, 20 ml of glutamic acid decarboxylase obtained in Experimental Example 1 was added to the sterilized mixture and cultured at 30° C. for 24 hours. The resulting enzyme treatment solution was filtered through a paper filter and Celite filter to remove the bacteria to obtain a clear brown solution. The GABA content in this solution was 3.2 mg/ml. Then, the resulting solution was freeze-dried. Consequently, 60 grams of the control powdery food material with 1.2% in GABA content was obtained.

Next, just as in the case with the above control, a mixture of wheat gluten, AO protease, and hot water was prepared. Then, 0.2 grams of Glutaminase Daiwa C-100 (manufactured by Daiwakasei, Co., Ltd.) as glutaminase was added to the mixture, allowing the decomposition reaction at 50° C. for 24 hours. After the decomposition, 20 ml of glutamic acid decarboxylase solution obtained in Experimental Example 1 was added to the mixture and cultured at 30° C. for 24 hours. The resulting culture was filtered through a paper filter and Celite filter to remove the bacteria to obtain a clear brown solution. The GABA content in this solution was 15.8 mg/ml. Then, the resulting solution was freeze-dried. Consequently, 60 grams of the powdery food material with 5.9% in GABA content of the present invention was obtained. In this example, just as in the case with Examples 1, 2, 3, and 4, the amount of GABA contained in the natural food material of the present invention is substantially higher than that of the control powdery food material.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

This application claims the priority of Japanese Patent Application Nos. 2001-27950 filed Feb. 5, 2001 and 2001-359291 filed Nov. 26, 2001, which are incorporated herein by reference.

What is claimed is:

1. A method for manufacturing a natural food material with a high content of γ-aminobutyric acid characterized by treating a glutamine-containing raw material with glutamic acid decarboxylase and glutaminase.

2. The method for manufacturing the natural food material with a high content of γ-aminobutyric acid as claimed in claim 1, wherein
a microorganism having an activity of glutamic acid decarboxylase is provided as said glutamic acid decarboxylase.

3. The method for manufacturing the natural food material with a high content of γ-aminobutyric acid as claimed in claim 1, wherein
said glutamine-containing raw material is one prepared by a decomposition of a glutamine-containing material with a proteolytic enzyme.

4. The method for manufacturing the natural food material with a high content of γ-aminobutyric acid as claimed in claim 1, wherein
a microorganism having an activity of glutaminase is provided as said glutaminase.

5. A natural food material with a high content of γ-aminobutyric acid, which is obtainable by the method as claimed in any one of claims 1 to 4.
